(19) United States
(12) Patent Application Publication
(10) Pub. No.: US 2004/0097222 A1
(43) Pub. Date: May 20, 2004

(54) Method for transmitting information data associated with the number of transmissions of a calling signal

(75) Inventors: Tomokazu Kake, Tokyo (JP); Yousuke Kimoto, Kanagawa (JP)

Correspondence Address: LERNER, DAVID, LITTENBERG,, KRUMHOLZ & MENTLIK, 600 SOUTH AVENUE WEST, WESTFIELD, NJ, 07090, US

(73) Assignee: Sony Computer Entertainment Inc., Tokyo (JP)

(21) Appl. No.: 10/632,783

(22) Filed: Aug. 1, 2003

Related U.S. Application Data
(63) Continuation-in-part of application No. 10/143,476, filed on May 10, 2002.

(30) Foreign Application Priority Data
Aug. 5, 2002 (JP) 2002-227679
May 16, 2001 (JP) 2001-145982
Feb. 26, 2002 (JP) 2002-050352

(51) Int. Cl. H04M 3/00

(52) U.S. Cl. 455/420; 455/418

(57) ABSTRACT

Appliance operation data that is desired to be transmitted is selected from a stored list in which transmission counts of a calling signal are associated with appliance operation data for operating household appliances. A transmitter controls a reading operation to read the transmission count corresponding to that appliance operation data and then transmits the calling signal only a number of times that is equal to that transmission count. A receiver retrieves from a stored list the appliance operation data corresponding to the number of times the calling signal is received, displays that appliance operation data on a display unit, and issues an instruction to operate the household appliance according to the retrieved appliance operation data. Accordingly, household appliances in the home may be remotely controlled under pre-set conditions without establishing a voice communication line between the transmitter and the receiver.

### CROSS-REFERENCE TO RELATED APPLICATIONS

This application is a continuation-in-part application of application Ser. No. 10/143,476, filed on May 10, 2002, and claims priority from Japanese Patent Application No. 2002-227679, filed on Aug. 5, 2002, the disclosures of which are hereby incorporated by reference herein.

### BACKGROUND OF THE INVENTION

The present invention relates to an information data transmission/reception method, an information data transmission method, an information data reception method, a computer-readable storage medium having recorded thereon an information data transmission program to be executed on a computer, a computer-readable storage medium having recorded thereon an information data reception program to be executed on a computer, a transmitter, a receiver, a transmitter-receiver, an information data transmission/reception system, an information data transmission program to be executed on a computer, and an information data reception program to be executed on a computer, all of which allow exchanging of messages and operating of household appliances from remote locations without establishing a voice/information communication line between a transmission terminal and a reception terminal.

Generally, a caller makes a telephone call in the hope that a communication party will answer the telephone. However, when the communication party is not available, the caller's telephone call to the communication party may result in connection to an answering machine. As a result, although the caller makes a telephone call in the hope that the communication party will answer the telephone, it proves to be disappointing.

In addition to telephones, there is, for instance, electronic mail as a means for transmitting messages to a communication party. In the case of electronic mail, since it is possible to transmit messages regardless of the availability of the communication party, messages may be transmitted when it is convenient for the sender. Thus, the sender of electronic mail transmits the electronic mail without hoping that the communication party will immediately open the transmitted message. Therefore, in the case of electronic mail, the same hope that the message will be immediately received is not created as with telephone calls. However, electronic mail is not capable of notifying the communication party of a message unless he or she activates, for instance, a personal computer and so forth and then executes the mail program on the personal computer.

Thus, the telephone system is not capable of communicating business unless the communication party immediately answers the telephone, and electronic mail is not capable of communicating messages to the communication party unless the communication party activates a personal computer and so forth and then opens the received electronic mail.

### SUMMARY OF THE INVENTION

The present invention provides an information transmission/reception method, an information transmission method, an information reception method, a computer-readable storage medium having recorded thereon an information transmission program to be executed on a computer, a computer-readable storage medium having recorded thereon an information reception program to be executed on a computer, a transmitter, a receiver, a transmitter-receiver, an information transmission/reception system, an information transmission system for causing a processor to execute instructions, and an information reception system for causing a processor to execute instructions, all of which allow exchanging of messages and operation of household appliances from remote locations easily and certainly without establishing a voice/information communication line between a transmission terminal and a reception terminal.

The present invention adds the meaning of a message to the transmission count of a calling signal sent to a communication party, and is thereby capable of transmitting and receiving messages simply.

Specifically, the present invention prepares a storage unit having stored therein predetermined information in which a unique transmission count of a calling signal corresponds to each message, and then a calling signal is sent to a transmission destination receiver so that the number of calling signals sent corresponds to the message to be transmitted. The transmission destination receiver reads out the message corresponding to the transmission count of a calling signal from a storage unit in which messages are stored, each in association with a unique number of calling signals, and then displays the message on a display unit.

According to this configuration, even though, for instance, a communication party does not answer the telephone, or the communication party is under any conditions or so forth, a message is capable of being transmitted and received under the predetermined conditions without establishing a voice communication line between the transmitter of the sender and the receiver of the recipient.

Furthermore, the present invention prepares a storage unit in which the number of transmissions of a calling signal, which is used for calling the communication party, corresponds to an appliance operation for remotely controlling a household appliance at a remote location, and then transmits the calling signal to a transmission destination receiver so that the calling signal is transmitted only a number of times that is equal to the number of transmissions of the calling signal that corresponds to the appliance operation desired to be operated. The receiver reads out the appliance operation that corresponds to the number of transmissions of the calling signal from a storage unit that is stored with appliance operations according to the number of transmissions of the calling signal, and then operates the household appliance according to that appliance operation.

In this manner, household appliances at a remote location may be remotely controlled under pre-set conditions without establishing a voice/information communication line between the transmitter and the receiver.

### BRIEF DESCRIPTION OF DRAWINGS

The above and other features will be better understood from the exemplary embodiments described below, taken together with the drawings, of which:

FIG. 1 is a schematic view illustrating the state in which a simple message is transmitted and received between message transmitter-receivers;

FIG. 2 is a block diagram of a message transmitter-receiver at the transmission side;

FIG. 3 is a block diagram of a message transmitter-receiver at the reception side;

FIG. 4 is a flowchart illustrating a transmission process for a simple message;

FIG. 5A is a view illustrating an exemplary display of a registrant list;

FIG. 5B is a view illustrating an exemplary display of a simple message list;

FIG. 5C is a view illustrating an exemplary display of a transmission screen;

FIG. 6 is a flowchart illustrating a process of receiving a simple message;

FIG. 7 is a view illustrating an exemplary simple message and the transmission count for a calling signal related to respective registrants;

FIG. 8A is a view illustrating an exemplary image of an incoming simple message;

FIG. 8B is a view illustrating an exemplary display of a received simple message;

FIG. 9 is a view illustrating an exemplary two-dimensional database for determining a to-be-transmitted message based on a first transmission count and a second transmission count of a calling signal;

FIG. 10 is a view illustrating the state of the two-dimensional database illustrated in FIG. 9 in which a message is selected based on the first and the second transmission counts;

FIG. 11 is a flowchart illustrating an operation of a message transmitter-receiver on the reception side ringing until it displays a simple message according to a second embodiment that determines a to-be-transmitted message based on the first transmission count and the second transmission count of the calling signal;

FIG. 12 is a schematic diagram illustrating an example of remotely controlling household appliances in the home from a fixed telephone or a portable phone;

FIG. 13 is a system block diagram illustrating an example of remotely controlling household appliances in the home from a fixed telephone or a portable phone;

FIG. 14 is a block diagram of a fixed telephone or a portable phone utilized in the system of FIG. 13;

FIG. 15 is a block diagram of a reception terminal device utilized in the system of FIG. 13;

FIG. 16 is a flowchart illustrating a transmission process for transmitting appliance operation information from a fixed telephone or a portable phone to a reception terminal apparatus in the system of FIG. 13;

FIG. 17A is a view illustrating an exemplary display of an appliance operation selection screen displayed on a display unit of a fixed telephone or a portable phone in the system of FIG. 13;

FIG. 17B is a view illustrating an exemplary display of when an appliance operation has been selected in the system of FIG. 13;

FIG. 18 is a flowchart illustrating an operation of the reception terminal apparatus in the system of FIG. 13;

FIG. 19 is a view illustrating an exemplary database which presents appliance operations and the transmission count of the calling signal allocated thereto in the system of FIG. 13;

FIG. 20 is a view illustrating an example where simple message information and appliance operation information are registered in the same database in the case where the transmission of a simple message and the remote control of the household appliances can be performed by one terminal device with two or more calling operations;

FIG. 21 is a flowchart illustrating an appliance operating process to be carried out by the reception terminal device in the case where the transmission of a simple message and the remote control of the household appliances can be performed by one terminal device with two or more calling operations; and

FIG. 22 is a view illustrating an example where an appliance to be operated by the first and second calls is selected in the case where the transmission of a simple message and the remote control of household appliances can be performed by one terminal device with two or more operations.

### DETAILED DESCRIPTION

Preferred embodiments of the present invention are described in detail below, with reference being made to the relevant accompanying drawings.

### FIRST EMBODIMENT

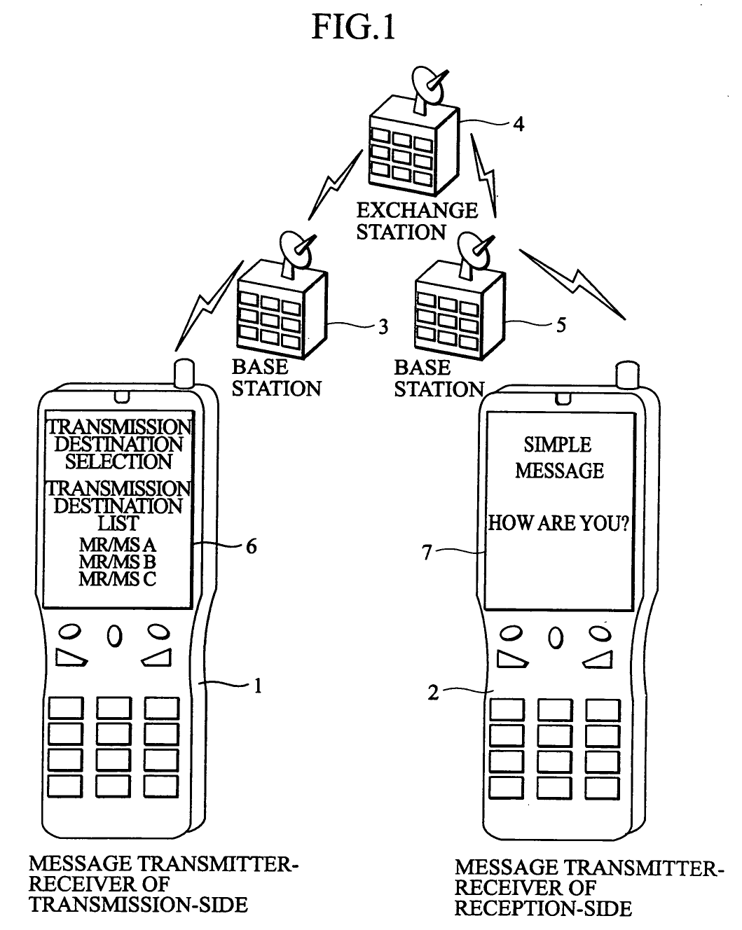

FIG. 1 illustrates a first embodiment in which the present invention is applied to a simple message transmitting and receiving system, where a simple message is capable of being transmitted and received between message transmitter-receivers 1 and 2, such as, for example, portable telephones, portable information terminals with a telecommunication facility, and so forth.

Specifically, the message transmitter-receiver 1 provided on the transmission side adds the telephone number of the message transmitter-receiver 2 on the reception side (incoming destination) to line establishment requiring signals, and then sends the line establishment requiring signals to an exchange station 4 via a base station 3 on the transmission side that detects position information of the message transmitter-receiver 1, thereby establishing a line between the exchange station 4 and the message transmitter-receiver 1. The exchange station 4 establishes a line between the message transmitter-receiver 2 on the reception side and the exchange station 4 via the base station 5 on the reception side. When the line is established, the message transmitter-receiver 1 on the transmission side or the exchange station 4 transmits calling signals to the message transmitter-receiver 2 on the reception side, where the number of times the calling signals are transmitted corresponds to the message desired to be transmitted to the communication party (reception destination).

The message transmitter-receiver 2 detects the sender based on the received calling signal, and also detects the number of transmissions of the calling signal (the number of times the calling signal has been sent). The message transmitter-receiver 2 then detects the message on the message list related to the sender depending on the number of calling signals received. After that, the message transmitter-receiver 2 displays the message on display unit 7 with a predetermined operation. In this simple message transmitting and receiving system, the number of calling signals received is uniquely related to the message. Accordingly, transmission and reception of a simple message is possible without establishing a voice communication line between the message transmitter-receivers 1, 2.

It should be noted that, as described above, it is alternatively possible that calling signal transmission and control of the number of times the calling signal is transmitted may be performed by the message transmitter-receiver 1 or the exchange station 4, or it is possible that transmission of the calling signal may be performed by the exchange station 4, and control of the number of times the calling signal is transmitted may be performed by the message transmitter-receiver 1. Further, it is possible that transmission of the calling signal may be performed by the message transmitter-receiver 1, and control of the number of times the calling signal is transmitted may be performed by the exchange station 4.

In the present embodiment, it is assumed that the message transmitter-receiver 1 sends information to the exchange station 4 regarding the number of times a calling signal corresponding to a selected message has been transmitted, and the exchange station 4 transmits to the message transmitter-receiver 2 on the reception side calling signals corresponding to the number of transmissions on the basis of the supplied information. In addition, it is assumed that FIG. 1 is an example in which messages are sent from the message transmitter-receiver 1 on the transmission side to the message transmitter-receiver 2 on the reception side. However, in the case where these message transmitter-receivers 1, 2 are provided with functions for transmitting and receiving simple messages, the message transmitter-receivers 1, 2 are capable of transmitting and receiving messages mutually.

### Configuration of Message Transmitter-Receiver

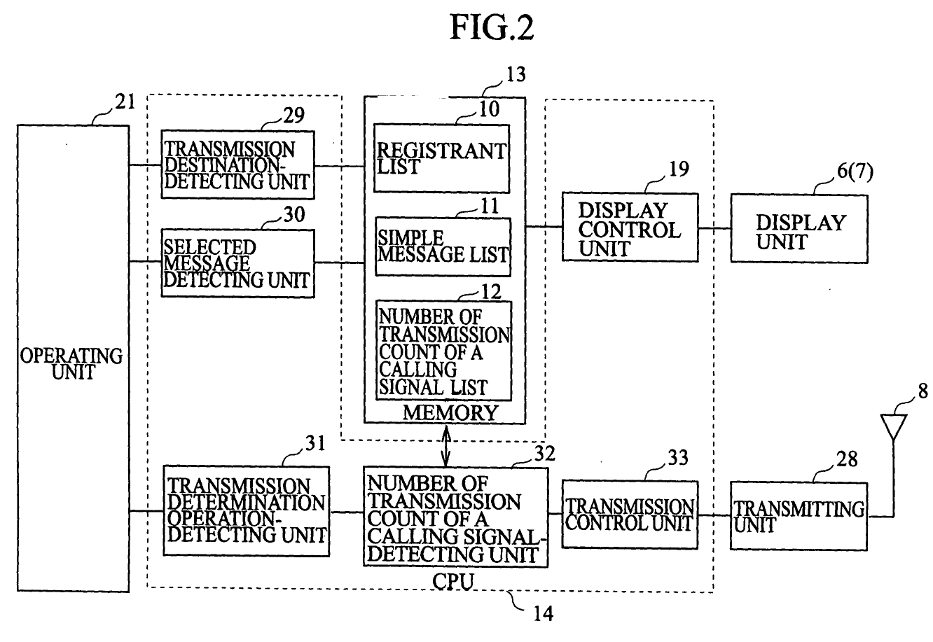

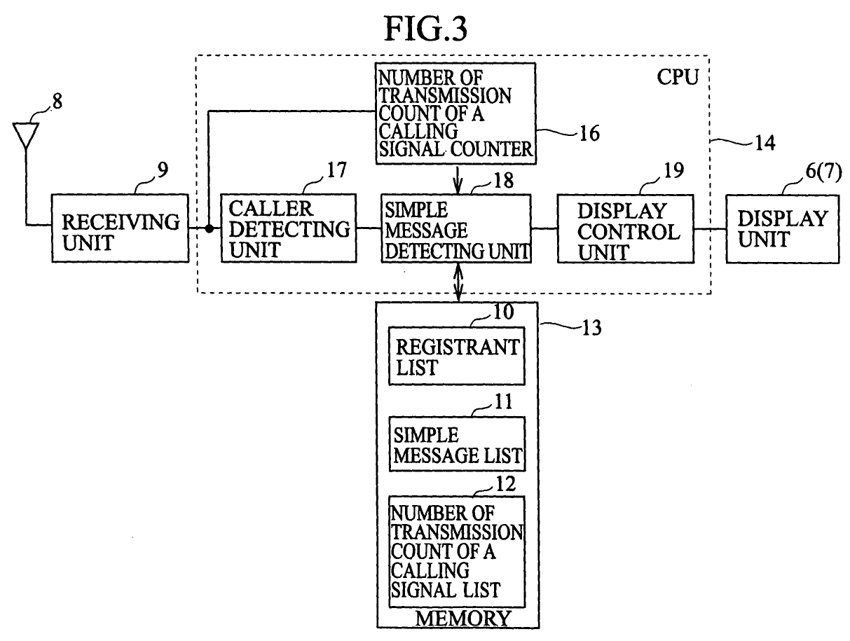

The message transmitter-receivers 1, 2 which are used in the simple message transmitting and receiving system have a transmission system as illustrated in FIG. 2 and a reception system as illustrated in FIG. 3. It should be noted that the message transmitter-receivers 1, 2 on both the transmission side and the reception side have the transmission system and the reception system. Therefore, the configuration of the transmission system and the reception system will be explained with reference to the message transmitter-receiver 1 on the transmission side, for instance, which is representative thereof.

### Configuration of Transmission System

To begin with, the transmission system of the message transmitter-receiver 1, as illustrated in FIG. 2, has an operating unit 21 operated by the sender at the time the simple message is transmitted, a memory 13 provided with a registrant list 10, a simple message list 11 and the transmission count of a calling signal list 12, a CPU 14 for controlling the number of transmissions of the calling signal (the number of times the calling signal has been sent) that correspond to the simple message to be transmitted to the transmission destination, and a transmitting unit 28 for transmitting via an antenna 8 the information regarding the number of times the calling signal has been sent.

The registrant list 10 of the memory 13 stores therein the names of respective registrants and the telephone numbers of the respective registrants. In addition, the simple message list 11 stores therein a plurality of simple messages, such as, for instance, “Good Morning!”, “Good Night!” and so forth. Further, the transmission count of a calling signal list 12 stores therein information indicating the number of calling signals that correspond to each simple message for every respective registrant.

The CPU 14 has a transmission destination-detecting unit 29 for detecting the transmission destination selected by the sender from among the registrant list 10 of the memory 13, a selected message detecting unit 30 for detecting a simple message selected by the sender from among the simple message list 11 of the memory 13, a transmission determination operation-detecting unit 31 for detecting a transmission determination operation by the operating unit 21 with regard to the simple message, and a display control unit 19 for displaying the list of registrants stored in the memory 13, the simple messages corresponding to the registrant and so forth on a display unit 6, such as a liquid crystal display and so forth (display unit 7 in the case of the message transmitter-receiver 2 at the reception side), on the occasion that the operator selects simple messages.

In addition, the CPU 14 has a number of times of calling-detecting unit 32 for detecting information concerning both the transmission destination selected by the sender and the number of calling signals corresponding to the simple message from among the number of times of calling signal list 12, and a transmission control unit 33 for controlling the transmitting unit 28 so as to transmit information concerning the number of calling signals detected by the transmission count of a calling signal-detecting unit 32.

The transmission destination-detecting unit 29 to the transmission control unit 33 operate as functions of the CPU 14 controlled by predetermined computer programs.

### Configuration of Reception System

The reception system of the message transmitter-receiver 1, as illustrated in FIG. 3, has a receiving unit 9 for receiving intermittent incoming calling signals via the antenna 8, and a CPU 14 for detecting the sender on the occasion that an incoming calling signal is received, and, when the sender is registered in the registrant list 10 of the memory 13, for reading out from the simple message list 11 a simple message corresponding to the sender depending on the transmission count of calling signals received and then displaying a corresponding simple message on the display unit 6.

The CPU 14 has the transmission count of a calling signal counter 16 for counting the number of times the calling signal is intermittently received at the receiving unit 9, a caller detecting unit 17 for detecting the caller, a simple message detecting unit 18 for detecting the simple message corresponding to the number of times the calling signal has been received while retrieving the memory 13 on the basis of both the number of calling signals counted by the transmission count of a calling signal counter 16 and the caller detected by the caller detecting unit 17, and a display control unit 19 for displaying the detected simple message and so forth on the display unit 7.

The transmission count of a calling signal counter 16 through the display control unit 19 operate as functions of the CPU 14 controlled by predetermined computer programs.

### Transmitting and Receiving Operation of Simple Message

The simple message transmitting and receiving operation in the simple message transmitting and receiving system will be explained for the case in which the message transmitter-receiver 2 on the reception side receives a simple message transmitted from the message transmitter-receiver 1 on the transmission side illustrated in FIG. 1.

### Transmitting Operation

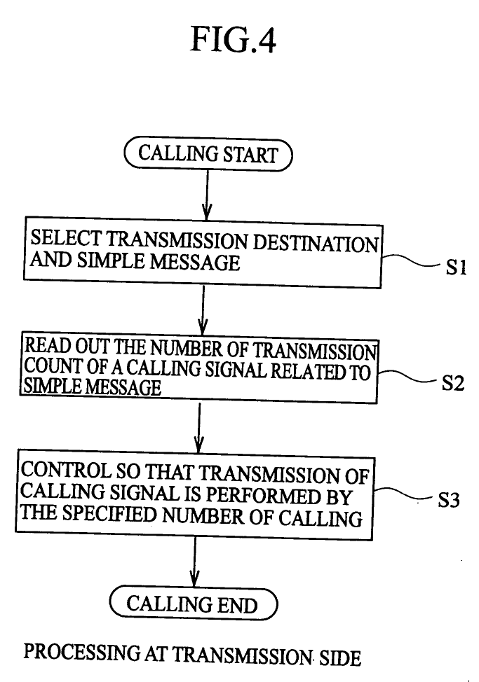

The flowchart of FIG. 4 indicates the process of transmitting a simple message from the message transmitter-receiver 1 provided on the transmission side. The flowchart starts (calling start) when the sender operates the message transmitter-receiver 1 and selects the transmission mode of the simple message.

When this transmission process is started, in STEP S1, the transmission destination-detecting unit 29 and the selected message detecting unit 30 detect the transmission destination of the simple message and the simple message being transmitted, respectively, on the basis of the output from the operating unit 21 operated by the user.

Specifically, in this transmission mode, the transmission destination-detecting unit 29 reads out the registrant list 10 the list of transmission destinations registered beforehand in the memory 13. Then, the display control unit 19 controls the registrant list 10 and displays it on the display unit 6 as a transmission destination selection screen.

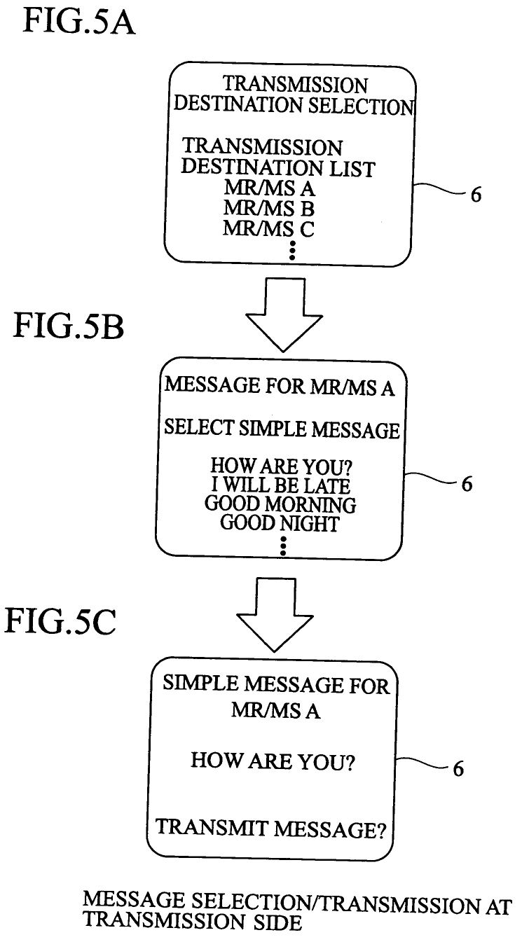

FIG. 5A illustrates an exemplary transmission destination selection screen displayed on the display unit 6. The respective registrants to be transmission candidates for the simple message, as illustrated in FIG. 5A, are displayed in a tabulated list on the display unit 6 by the display control unit 19. For example, the list may be displayed as Mr./Ms. A, Mr./Ms. B, Mr./Ms. C, and so forth.

The user selects the registrant to whom the simple message is to be transmitted from among the respective registrants displayed as described above by operating the operating unit 21. The transmission destination-detecting unit 29 detects the transmission destination to be the registrant selected by the user on the basis of the output from the operating unit 21 and then reads out the simple message list that is allocated to the selected registrant beforehand from among the simple message list 11 of the memory 13. The display control unit 19 then controls the simple message list 11 and displays it on the display unit 6.

FIG. 5B illustrates an exemplary simple message list 11 displayed on the display unit 6. The simple message list 11, as illustrated in FIG. 5B, includes simple messages, such as, for instance, “How are you?”, “I will be late.”, “Good Morning.”, “Good Night.” and so forth, which are displayed on the display unit 6 in a tabulated list by the display control unit 19.

The user operates the operating unit 21 to select the desired simple message from the simple message list 11 that is displayed on the display unit 6. The selected message detecting unit 30 detects the simple message selected by the user on the basis of the output from the operating unit 21. When the simple message selected by the user is detected, the display control unit 19, as illustrated in FIG. 5C, controls the display unit 6 to display the simple message selected by the user and a message inquiring as to whether the simple message is to be transmitted.

FIG. 5C illustrates the exemplary simple message of “How are you?” selected by the user, and the exemplary message of “transmit message?” inquiring whether the simple message should be transmitted. These messages are displayed on the display unit 6.

When a transmission instruction is output by the user via the operating unit 21 in response to the transmission inquiry message, the transmission determination operation-detecting unit 31 outputs this transmission instruction to the transmission count of a calling signal-detecting unit 32.

The transmission count of a calling signal-detecting unit 32, in STEP S2 of the flowchart of FIG. 4, accesses the memory 13 on the basis of the transmission destination detected at the transmission destination-detecting unit 29 and the simple message detected at the selected message detecting unit 30. The transmission count of a calling signal-detecting unit 32 detects from the memory 13 the transmission count of a calling signal allocated to the simple message to be transmitted to the transmission destination, and provides the detection output to the transmission control unit 33.

Namely, as shown in the example, where one time is allocated as the transmission count of a calling signal for the simple message of “How are you?” to Mr./Ms. A as the transmission destination, and three times is allocated as the transmission count of a calling signal for the simple message of “Good morning.” to Mr./Ms. A as the transmission destination, and so forth, the simple message is related to the transmission count of a calling signal and the simple messages related to the respective transmission counts of a calling signal are stored in the memory 13.

It should be noted that a transmission count of two calling signals may be allocated to the simple message of “How are you?” to Mr./Ms. B as the transmission destination, which is different from the transmission count of a calling signal for Mr./Ms. A as the transmission destination. Also, a transmission count of five calling signals may be allocated to the simple message of “Good morning.” to Mr./Ms. B as the transmission destination, and so forth, where the transmission count of calling signals for respective simple messages may be determined arbitrarily between the sender and the recipient.

The transmission count of a calling signal-detecting unit 32, when the transmission destination is detected at the transmission destination-detecting unit 29, detects the transmission count of a calling signal allocated to the simple message to be transmitted to the transmission destination from the transmission count of a calling signal list 12 of the memory 13 in STEP S2, and provides the detection output to the transmission control unit 33.

The transmission control unit 33, in STEP S3 of the flowchart of FIG. 4, controls the transmitting unit 28 so that the calling signal is transmitted only a number of times corresponding to the detected number of transmissions of the calling signal (the number of times the calling signal is to be sent). Namely, the transmission control unit 33 controls the transmitting unit 28 so as to transmit information regarding the number of transmissions of the calling signal (information regarding the number of times the calling signal is to be sent) to the exchange station 4. In addition, the transmission control unit 33 controls the transmitting unit 28 so as to transmit both the telephone number of the transmission destination and the line establishment requiring signal leading up to the incoming call destination to the exchange station 4. According to this process, the transmission process of the simple message illustrated in the flowchart of FIG. 4 is terminated (calling termination).

The transmitting unit 28 transmits information regarding the telephone number of the transmission destination, information regarding the transmission count of a calling signal, and the line establishment requiring signal via the antenna 8, and then these transmitted signals are received in the exchange station 4 via the base station 3 of the transmission side illustrated in FIG. 1. The exchange station 4 establishes a line with the message transmitter-receiver 2 of the transmission destination via the base station 5 of the reception side, and, after that, transmits the calling signal to the message transmitter-receiver 2 of the transmission destination only the number of times corresponding to the simple message to be sent to the transmission destination.

### Receiving Operation

The following description is an explanation of the receiving operation of the message transmitter-receiver 2 as the message transmitter-receiver 2 receives a simple message.

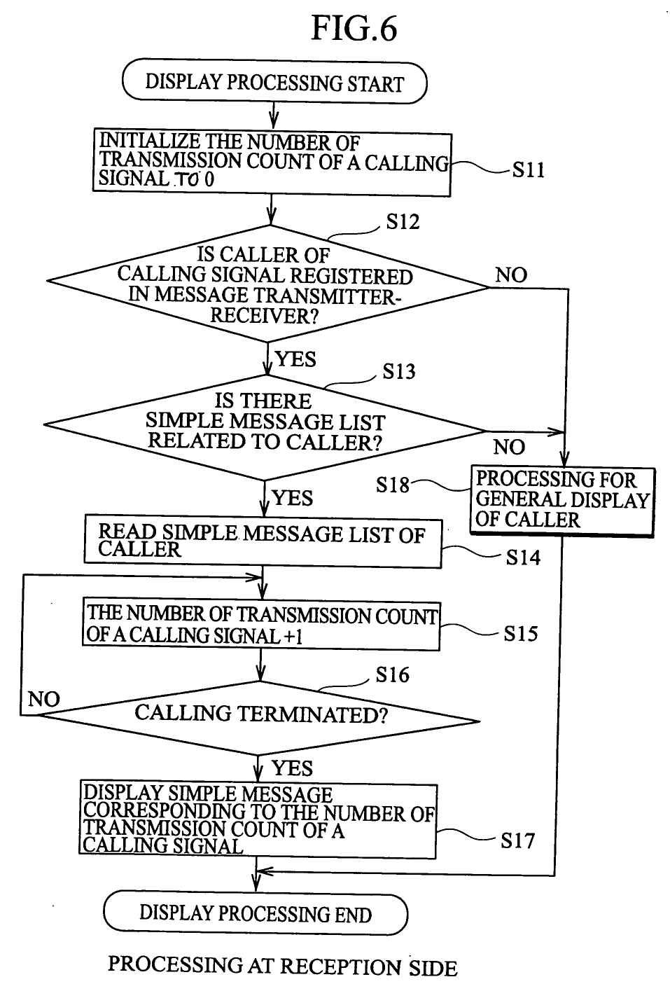

The flowchart of FIG. 6 indicates the process of receiving simple messages in this message transmitter-receiver 2. The receiving process of this flowchart starts (display processing start) at the time the receiving unit 9 illustrated in FIG. 3 detects an incoming calling signal.

The transmission count of a calling signal counter 16 of the CPU 14, in STEP S11, initializes the count value of the calling signal to 0 (zero) at the time the calling signal is detected at the receiving unit 9. Then, the receiving process proceeds to STEP S12.

The caller detecting unit 17, in STEP S12, retrieves information regarding the telephone number of the caller transmitted together with the line establishment requiring signal, and then determines whether the information regarding the telephone number of the caller is registered in the information of the telephone numbers of the respective registrants stored in the registrant list 10 of the memory 13 (namely, whether the sender is registered in the memory 13 of the message transmitter-receiver 2), and provides the determination output to the simple message detecting unit 18.

When the caller detecting unit 17,in STEP S12, has determined that the sender is registered in the message transmitter-receiver 2, the receiving process proceeds to STEP S13, whereas, when the caller detecting unit 17 has determined that the sender is not registered in the message transmitter-receiver 2, the receiving process proceeds to STEP S18.

The simple message detecting unit 18, in STEP S18, provides information regarding the telephone number of the transmission source to the display control unit 19, and then the display control unit 19 performs general caller display processing to display the information regarding the telephone number on the display unit 6, thereafter terminating the receiving process.

On the other hand, when the caller detecting unit 17 has determined that the caller is registered in the message transmitter-receiver 2 and the receiving process proceeds to STEP S13, the simple message detecting unit 18, in STEP S13, retrieves the registrant list 10 from the memory 13 to determine whether a simple message has been registered with respect to the caller.

When the simple message detecting unit 18, in STEP S13, has determined that there is no simple message registered with respect to the caller, the receiving process proceeds to STEP S18, and the display control unit 19 performs the above-described general caller display processing. On the other hand, when the caller detecting unit 17 determines that there is a simple message registered with respect to the caller, the receiving process proceeds to STEP S14.

The simple message detecting unit 18, in STEP S14, reads the simple message list corresponding to the caller from the simple message list 11 in the memory 13. Next, the transmission count of a calling signal counter 16, in STEP S15, counts the number of calling signals received by adding 1 (one) to the count value initialized at STEP S11 for each incoming calling signal detected.

The transmission count of a calling signal counter 16, in STEP S16, determines that calling is terminated when it detects the elapse of a definite period of time after the incoming calling signals have stopped, and then provides the count value of the calling signals counted at STEP S15 to the simple message detecting unit 18. After this processing, the receiving process proceeds to STEP S17.

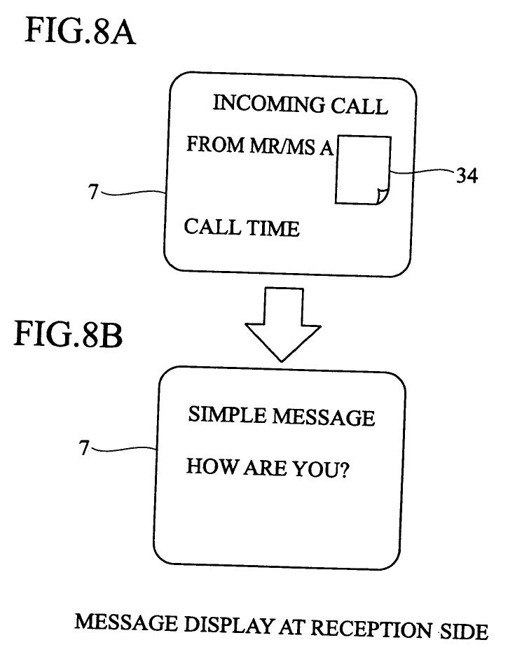

The display control unit 19, when a simple message is detected by the simple message detecting unit 18, for example, as illustrated in FIG. 8A, causes the display unit 7 to display the words “incoming call” indicating that there is an incoming call of a simple message, words indicating the sender of this simple message (in this example, the words “from Mr./Ms. A”), the “call time”, and a mark 34 indicating that the simple message has not been read.

The user at the reception side recognizes that his/her message transmitter-receiver 2 has received a simple message by seeing the mark 34, and then operates the operating unit 21 so as to display this simple message.

The simple message detecting unit 18, when detecting the display operation of this operating unit 21, in STEP S17, determines the caller detected by the caller detecting unit 17 and the simple message that corresponds to the transmission count of a calling signal detected by the transmission count of a calling signal counter 16 from the simple message list 11 read at STEP S14, and then provides the simple message to the display control unit 19. The display control unit 19 displays this simple message on the display unit 7.

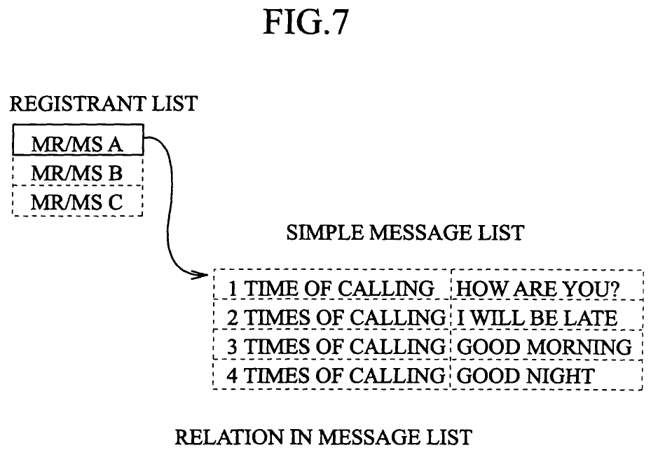

Specifically, for example, in the case where the caller detected by the caller detecting unit 17 is the caller Mr./Ms. A, and the number of times the calling signal is detected by the transmission count of a calling signal counter 16 is one time, the simple message detecting unit 18, as illustrated in FIG. 7, detects the simple message “How are you?” as the simple message corresponding to the one calling signal from this caller Mr./Ms. A from the simple message list 11, and then provides the simple message to the display control unit 19. According to this processing, as illustrated in FIG. 8B, the display unit 7 displays the simple message “How are you?”

It should be noted that, in the case of this example, if two calling signals from the caller Mr./Ms. A are detected, the simple message of “I will be late.” is displayed on the display unit 7; if three calling signals from the caller Mr./Ms. A are detected, the simple message of “Good morning” is displayed on the display unit 7; and if four calling signals from the caller Mr./Ms. A are detected, the simple message of “Good night” is displayed on the display unit 7. The receiving process illustrated in the flowchart of FIG. 6 is terminated with the display of the simple message.

Incidentally, with the above embodiment, regardless that the transmission of a message to the destination communication party has been attempted, there is a chance that the phone will be answered when the calling tone occurs at the reception side. In this case, the sender is not able to transmit the message to the communication party since the communication party may answer the phone before the expected number of transmissions have occurred. For that reason, when an incoming call occurs, the message transmitter-receiver 2 on the reception side notifies only that there is a message without giving off a calling tone.

For example, with the message transmitter-receiver 2, if there are four messages registered as in the simple message list illustrated in FIG. 7, a tone is not allowed to be given off up through the fourth, but when five or more transmissions are issued, the calling tone is given off as a normal telephone call for the first time. Namely, the calling tone is kept from occurring until more transmissions are issued than the number of transmissions registered for the messages. This may prevent the recipient from improperly answering the phone. This is particularly useful for incoming calls from a sender that is registered as a sender of simple messages.

It should be noted that, generally, the calling signal at the time of transmission and reception has a definite signal length. However, a calling signal that is less than the definite signal length may result when the sender cancels the transmission immediately after transmitting the calling signal or from another factor regarding the calling signals. For that reason, a signal length that is less than the definite signal length at the time of transmission and reception is not counted as a calling signal.

For example, the signal length that acts as a reference at the time of counting the calling signals upon transmission or reception is taken to be “1”. When the signal length at the time of transmission or reception is “0.3”, this calling signal is not counted because the signal length “0.3” of this calling signal is less than the signal length “1” of the reference. On the other hand, when the signal length of the calling signal at the time of transmission or reception is a signal length “1.3”, this calling signal is counted because a calling signal with a signal length “1.3” is longer than the signal length “1” of the reference.

As is clear from the explanation provided above, the simple message transmitting and receiving system of this embodiment uniquely relates the transmission count of a calling signal to a message to be sent and adds the meaning of the message to the transmission count of the calling signal itself. For that reason, the message is capable of being transmitted to the transmission destination by only transmitting the calling signal a number of times corresponding to the message desired to be sent without establishing a voice communication line.

The message is transmitted when the sender selects the transmission destination of the message and the message to be transmitted and performs a transmission operation, at which point a predetermined transmission count of a calling signal corresponding to the message to be transmitted is transmitted to the transmitter-receiver of the transmission destination. For that reason, it is not necessary to conduct troublesome operations, such as inputting the address of the communication party destination, a header and a message in electronic mail, and so forth. Thus, the message is capable of being transmitted to the transmission destination with a simple operation and in a short period of time.

In addition, the user is capable of receiving the simple message without operating the message transmitter-receiver 2 consciously, such as in answering the telephone, because the simple message is received automatically by the message transmitter-receiver 2.

The message transmitter-receiver 2 at the reception side, when it receives the simple message, creates a display, such as the mark 34 illustrated in FIG. 8A, to notify the user of the incoming simple message. For that reason, the user is notified of an incoming simple message by this mark 34, even when the simple message is received automatically.

### MODIFIED EXAMPLE

The message transmitter-receivers 1, 2 in the first embodiment are described as having both the functions of message transmission and reception, however, these message transmitter-receivers 1, 2 may possess only a message transmitting function or only a message receiving function.

The simple message transmitting and receiving system of the first embodiment displays a text message corresponding to the detected transmission count of a calling signal, however, it is alternatively possible that a static image, a moving image or a voice message may be displayed or output in place of the text message. For example, a static image such as an icon, character and so forth may represent a certain message, and these icons and/or characters are displayed depending on the detected transmission count of a calling signal, whereby it is possible to obtain the same effect as described above. In addition, it is possible that text, static images, moving images and voice may be combined appropriately to form a message depending on the detected transmission count of a calling signal, and then may be displayed or output as the simple message.

In addition, in the first embodiment, the message which corresponds to the detected transmission count of a calling signal as agreed upon beforehand between the sender and the recipient is displayed. However, it also may be possible to display fixed simple messages which correspond solely to the detected transmission count of a calling signal, and not to the sender. For example, the simple message “How are you?” may be displayed if the detected transmission count of a calling signal is one, the simple message “Good morning.” may be displayed if the detected transmission count of a calling signal is three, and so forth, regardless of whether the incoming call is from Mr./Ms. A or from Mr./Ms. B or any other sender.

In addition, in the first embodiment, processing at the transmission side and the reception side may be accomplished by reading out a message transmission program or a message reception program stored in the memory within the message transmitter-receiver, or by reading out a message transmission program or a message reception program stored in an external memory.

When the message transmission program or the message reception program is stored in an external memory, the external memory may be connected to a memory slot in the message transmitter-receiver, and the message transmitter-receiver may read out and execute the message transmission program or the message reception program from the external memory.

It is also possible for the message transmission program or the message reception program to be installed on the message transmitter-receiver from a storage medium such as a CD-ROM, DVD-ROM and so forth, or by downloading such programs to the message transmitter-receiver from a predetermined network such as the Internet and so forth.

In addition, the embodiment described-above is an example in which the present invention is applied to a simple message transmitting and receiving system for transmitting and receiving a simple message by using portable telephones. However, the present invention, other than this example, may be applied to any systems which employ communication equipment capable of transmitting calling signals, such as a fixed type (installed type) telephone having a display, such as a liquid crystal display, a facsimile machine, and so forth. The present invention may be used between different apparatuses, for example, where the transmission side is a portable telephone and the reception side is a facsimile machine, or the transmission side is a fixed type telephone and the reception side is a facsimile machine, and so forth.

It should be noted that, in the case that the system employs a facsimile machine, it is possible to output a simple message (or static image or so forth) corresponding to the transmission count of a calling signal received by printing the simple message on facsimile paper.

### SECOND EMBODIMENT

The second embodiment is an example where message transmission and reception are performed with two or more calling operations rather than with just one. In other words, calls through several operations are taken to be one message, where one message is obtained from a multi-dimensional database. Hereafter, this embodiment will be described in detail.

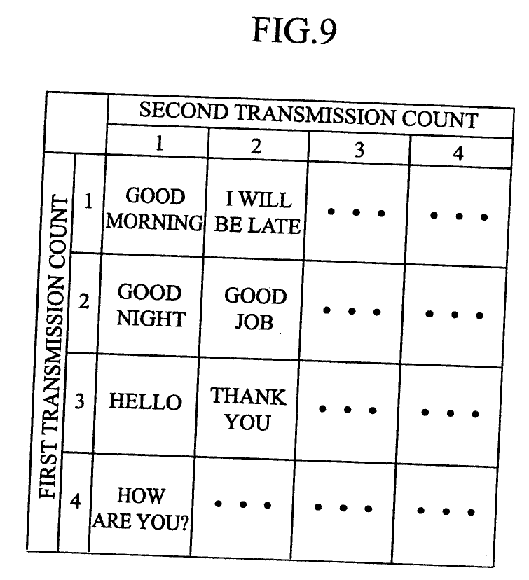

FIG. 9 is an exemplary two-dimensional database for determining a message to be transmitted based on the first and the second transmissions. In the two-dimensional database of FIG. 9, the number of transmissions of the first calling signal (the first transmission count) may be 1, 2, 3 or 4, and the number of transmissions of the second calling signal (the second transmission count) may be 1, 2, 3 or 4, resulting in a total of sixteen registered messages. It should be noted that an n-dimensional database is provided in order to determine the message to be transmitted based on the transmissions of the nth calling signal.

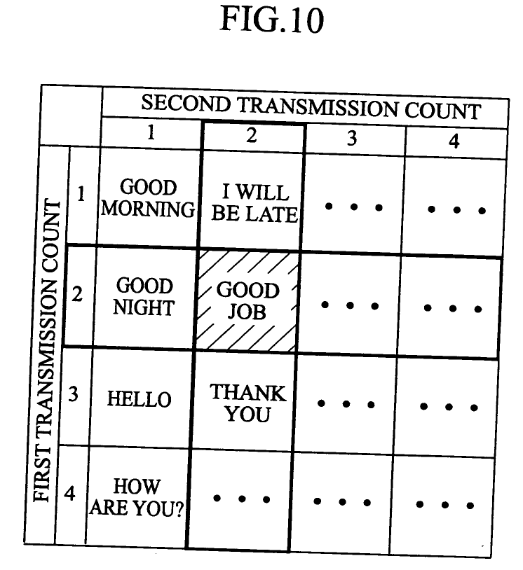

With the two-dimensional database illustrated in FIG. 9, when transmitting a message that says, for example, “Good Job”, as illustrated in FIG. 10, the transmission count of the first calling signal is two, and the transmission count of the second calling signal is two. Namely, to transmit a message that says “Good Job”, the calling signal is sent two times for the first transmission, and subsequently, the calling signal is sent two times for the second transmission. Similarly, to transmit a message that says “How are you?”, the calling signal is sent four times for the first transmission, and the calling signal is sent one time for the second transmission.

In this manner, determining the message to be transmitted using two calling operations allows a reduction in the number of transmissions based on calling signals in comparison to the case of transmitting a message using one operation. Namely, if a total of sixteen messages, for example, are provided, the maximum sixteen calling signals must be sent for transmitting a message using one calling operation. However, only eight transmissions, half the number, are necessary at maximum for transmitting a message using two calling operations.

As illustrated in FIG. 10, if the transmission count of the first calling signal is two, the messages “Good Night” and “Good Job”, which are enclosed with horizontal solid lines, are selected. If the transmission count of the second calling signal is two, the messages “I will be late”, “Good Job” and “Thank you”, which are similarly enclosed with vertical solid lines, are then selected, whereby the message of “Good Job”, which is indicated by slanted lines in the region where those solid lines cross, is ultimately determined.

On the other hand, at the reception side, the message transmitter-receiver 2 has the same two-dimensional database as in FIG. 9, receives two transmissions for the first calling signal, and subsequently, when two transmissions for the second calling signal have been received, displays the message “Good Job” on the display unit 7 of the message transmitter-receiver 2 on the reception side.

Next, simple message transmission and reception operations employing this two-dimensional database will be described. Since simple message transmission and reception is basically the same as with the first embodiment, the portions differing from the first embodiment will be described in detail.

To begin with, the user (sender) selects a communication party (registrant that is stored in the memory 13) to which a simple message is to be transmitted by operating the message transmitter-receiver 1 on the transmission side, reads out from the memory 13 the simple message list that is allocated to the selected communication party (recipient) beforehand, and selects the message desired to be transmitted from that simple message list. Here, it is assumed that the user desires to transmit a message that says “Good Job”. In addition, when this message is selected, the number of transmissions of a calling signal allocated to the simple message to be transmitted to that sender is detected. For the simple message of “Good Job”, each transmission count is detected: a transmission count of two is detected for the first calling signal; and a transmission count of two is also detected for the second calling signal.

Next, the message transmitter-receiver 1 on the transmission side transmits the calling signal the number of times that is equal to the detected calling signal transmission count, and transmits to the exchange station 4 both the telephone number of the transmission destination and the line establishment requiring signal leading up to the incoming call destination. The exchange station 4 establishes a communication line with the message transmitter-receiver 2 of the transmission destination via the base station 5 of the reception side, and subsequently transmits the calling signal to this message transmitter-receiver 2 the number of times that is equal to the aforementioned transmission count. In this example, the exchange station 4 transmits the calling signal two times for the first transmission, and then transmits the calling signal two times for the second transmission.

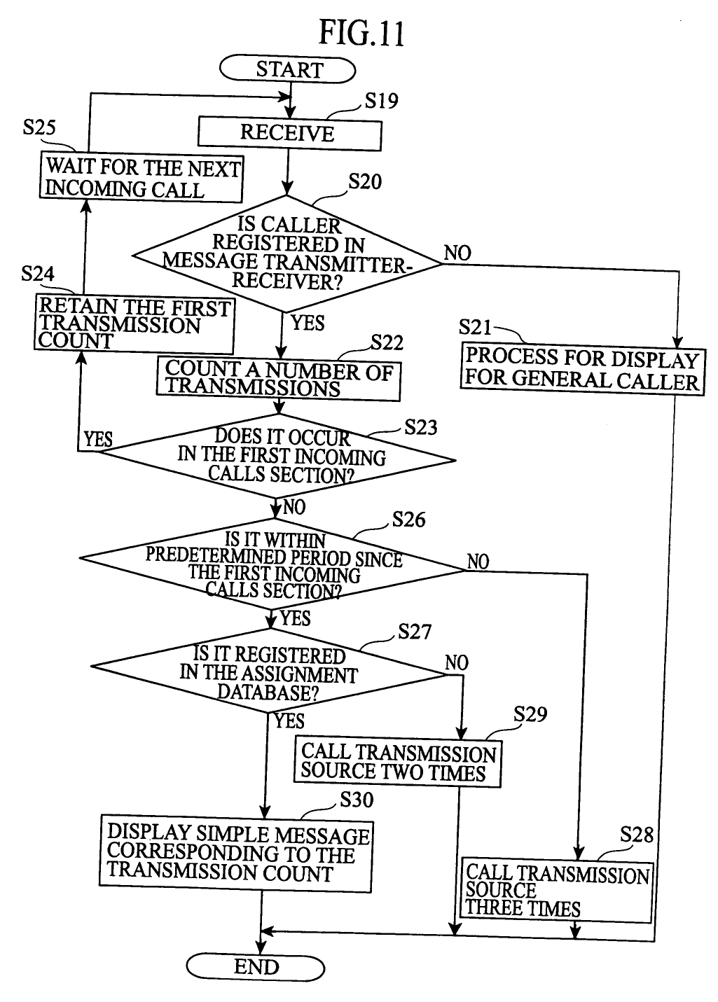

The message transmitter-receiver 2 on the reception side receives a message in the following manner. This receiving operation will be described with reference to the flowchart of FIG. 11. To begin with, this receiving process for a simple message starts when the power source of the message transmitter-receiver 2 on the reception side is turned on, and in STEP S19, the receiving unit 9 detects an incoming calling signal. In STEP S20, it is determined whether the caller is registered in this message transmitter-receiver 2. Namely, in STEP S20, the caller detecting unit 17 determines whether the telephone number of the transmission source is registered in the registrant list 10 that is stored in the memory 13. When the telephone number of the transmission source is not registered in the registrant list 10 and/or the telephone number is not notified, the call is processed (displays information regarding the telephone number on the display unit 6) as a normal telephone call in STEP S21, thereafter terminating the receiving process.

In STEP S20, in the case where the telephone number is registered in the registrant list 10, the receiving process proceeds to STEP S22. In STEP S22, the transmission count of a calling signal counter 16 initializes the count value for the calling signal to 0 (zero), thereafter counting the number of transmissions of the calling signal. Next, in STEP S23, the CPU 14 detects how many times there have been incoming calls from that same telephone number, and if they occur within the first incoming calls section, the receiving process proceeds to STEP S24. In STEP S24, the CPU 14 saves in the memory 13 the count of the calls received at the time of the first incoming calls section. In this example, the CPU 13 saves a count value of two for the first incoming calls section in the memory 13. Next, in STEP S25, the message transmitter-receiver 2 on the reception side waits for the next incoming call.

On the other hand, in STEP S23, in the case the incoming call is within the second incoming calls section instead of the first incoming calls section, the CPU 14 proceeds to STEP S26 of the receiving process. In STEP S26, the CPU 14 determines whether a predetermined time has elapsed since the first incoming calls section (for example, an elapse of one hour or more). Namely, in STEP S26, in the case where the second incoming calls section occurs within the predetermined time since the first incoming calls section, it is processed as an operation of receiving one message by a plurality of calling operations, thereby the receiving process proceeds to STEP S27.

Furthermore, in STEP S26, in the case where the second incoming calls section occurs more than a predetermined time after the first incoming calls section, the CPU 14 proceeds to STEP S28 of the receiving process. In STEP S28, the CPU 14 notifies the sender that the operation by the second incoming calls section is invalid by calling the transmission source three times, thereby the message transmitter-receiver 2 on the reception side returns to the state of waiting for an incoming call. At this time, the count of calls from the same telephone number is reset, whereby the process may be started again by making a first call.

When the second incoming calls section has occurred within the predetermined time since the first incoming calls section, the simple message detecting unit 18 accesses the two-dimensional database (assignment database) that is stored in the memory 13 in STEP S27, and detects whether the message that is determined from the count of the first incoming calls section and the count of the second incoming calls section is registered in this two-dimensional database. In the case where it is not registered in the two-dimensional database, the receiving process proceeds to STEP S29. In STEP S29, the CPU 14 makes two calls to the transmission source, notifying the transmission source that the simple message corresponding to the transmission count is not registered in the two-dimensional database.

On the other hand, in the case where the simple message corresponding to the counts of the first and second incoming calls sections is registered in the two-dimensional database, the simple message detecting unit 18 in the next STEP S30 gives the simple message detected to the display control unit 19. The display control unit 19 then displays that simple message on the display unit 7. In this example, the number of transmissions of the first calling signal is two and the number of transmissions of the second calling signal is likewise two. Therefore, the simple message of “Good Job” is displayed on the display unit 7.

### MODIFIED EXAMPLE

With the second embodiment, a two-dimensional database has been used to determine a simple message to be transmitted based on the transmission count of the first calling signal and the transmission count of the second calling signal. However, the present invention may also use an n-dimensional database to determine the simple message with the transmission count of an n^{th} calling signal. In this manner, using a multi-dimensionally structured database allows transmission of a message to the communication party with fewer transmissions than with the one-dimensional database, and allows more simple messages to be registered in the database.

### THIRD EMBODIMENT

The third embodiment is an example where electrical devices in the home (household appliances) may be operated from remote locations according to the transmission count of a calling signal from a telephone terminal device.

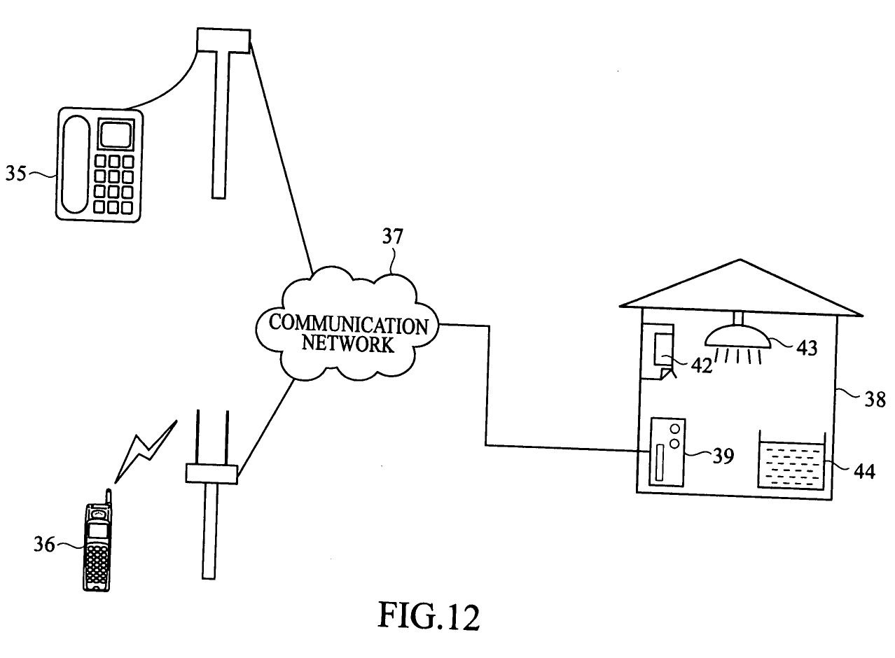

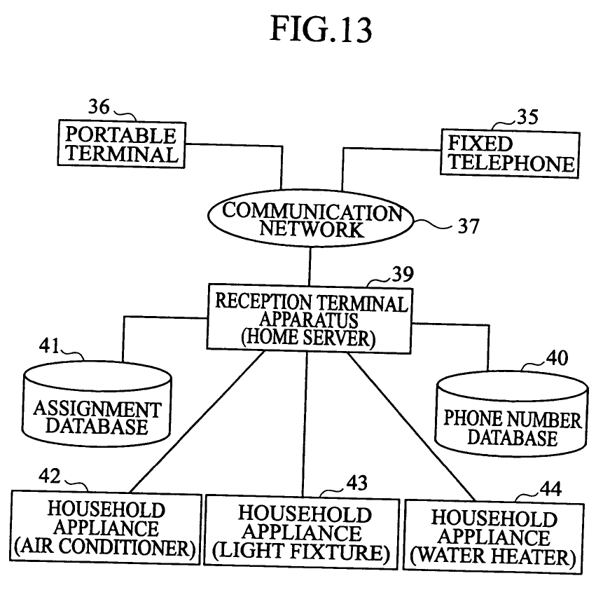

Specifically, as illustrated in the schematic diagram of FIG. 12 and the system block diagram of FIG. 13, when a user performs operations of transmitting a calling signal a predetermined number of times to a reception terminal device (home server) in the home 38 from a telephone terminal device, such as a fixed telephone 35 or a portable terminal (portable telephone) 36, via a communication network 37, a reception terminal device 39 determines whether the incoming telephone number is registered in a telephone number database 40, and if it is registered therein, reads out appliance operation data corresponding to the transmission count at the time of that incoming calls section from an assignment database 41 that stores data that relates the count of transmissions to the operations of the household appliances, and based on that appliance operation data operates various household appliances, for example, an air conditioner 42, a light fixture 43, a water heater 44 or the like, which are connected to the reception terminal device 39.

With this embodiment, operating various household appliances in a home 38 from remote locations is possible by corresponding the transmission count of a calling signal to the operation of the household appliances without establishing a voice/information communication line between the transmission terminal and the reception terminal.

### Configuration of Telephone Terminal Device

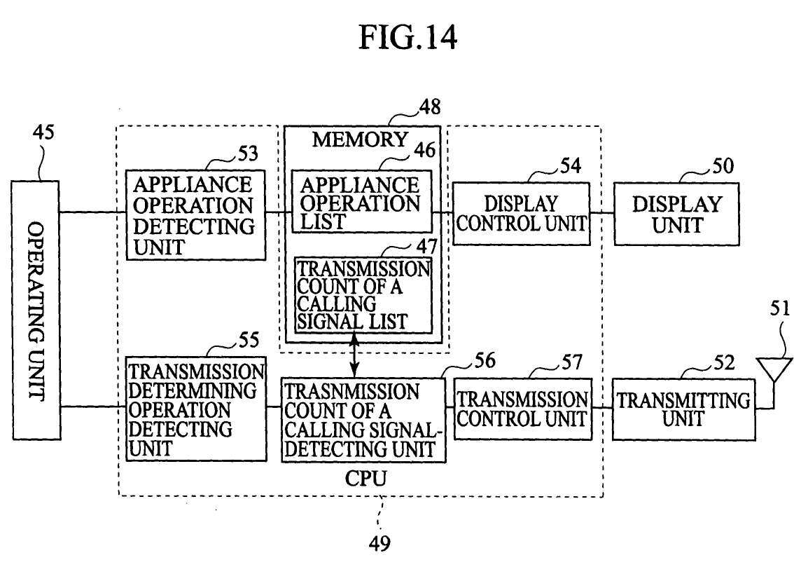

The telephone terminal device, such as the fixed telephone 35 or the portable terminal 36, as illustrated in the block diagram of FIG. 14, has an operating unit 45 operated by the sender at the time the household appliances are operated, a memory 48 stored with an appliance operation list 46 and a transmission count of a calling signal list 47, a CPU 49, a display unit 50 for displaying the appliance operations or the like, and a transmitting unit 52 for transmitting via an antenna 51 the transmission count of a calling signal allocated to the appliance operations.

The appliance operation list 46, which is in the memory 48, stores information for operating the various household appliances, such as the air conditioner 42, the light fixture 43 or the water heater 44 in the home. The appliance operation list 46 has information such as, for example, turn on air conditioner, turn off air conditioner, heat bath, turn on lights, turn off lights, and reset all for resetting the appliance operations. The transmission count of a calling signal list 47 stores information indicating the transmission count that corresponds to the appliance operation data. For example, the appliance operation of turning on the air conditioner is allocated a transmission count of one, and the appliance operation of turning off the air conditioner is allocated a transmission count of two.

The CPU 49 has an appliance operation detecting unit 53 for detecting appliance operation information selected by the user by reading out the appliance operation list 46 from the memory 48, a display control unit 54 for displaying the read out information of the appliance operation list 46 onto the display unit 50, a transmission determining operation detecting unit 55 for detecting the transmission-determining operation for the selected appliance operation, a transmission count of a calling signal-detecting unit 56 for detecting from the transmission count of a calling signal list 47 information indicating the transmission count corresponding to the selected appliance operation, and a transmission control unit 57 for controlling the transmitting unit 52 so as to transmit this information of the transmission count.

The display control unit 54, appliance operation detecting unit 53, transmission determining operation detecting unit 55, transmission count of a calling signal-detecting unit 56, and transmission control unit 57 operate as functions of the CPU 49, which executes these functions in conformity with predetermined computer programs.

### Configuration of Reception Terminal Device

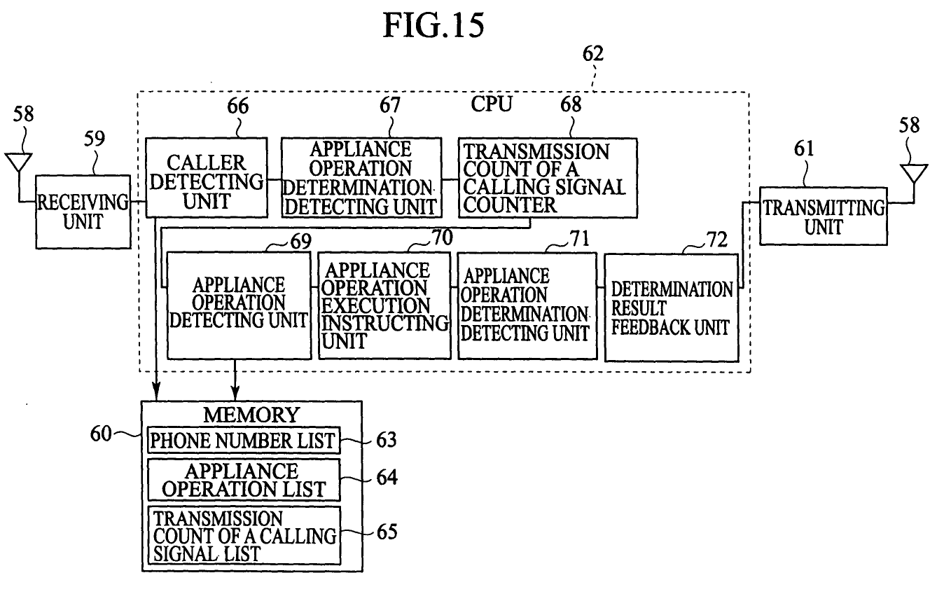

The reception terminal device 39 located in the home has, as illustrated in the block diagram of FIG. 15, a receiving unit 59 for receiving intermittent incoming calling signals via the antenna 58, a memory 60 for storing the telephone numbers of the fixed telephone 35 or the portable terminal 36 utilized in transmission and appliance operation information that is used to operate household appliances according to the number of transmissions, or the like, a CPU 62 for operating the appliance such that the appliance is operated according to the number of transmissions and for transmitting to a transmitting unit 61 information for feeding back to the sender whether the appliance has properly operated in the case where the telephone number of the sender is registered in the memory 60 at the time of incoming calls, and a transmitting unit 61 for transmitting that feedback information to the fixed telephone 35 or the portable terminal 36 via the antenna 58.

The memory 60 stores a telephone number list 63 including the telephone number of the fixed telephone 35 or the portable terminal 36 used in remote control, an appliance operation list 64 including operation information for turning on and off the air conditioner 42, the light fixture 43 or the like, and a transmission count of a calling signal list 65 including the transmission count of a calling signal corresponding to each operation of those appliances. The telephone number list 63 is read out from the telephone number database 40 and then stored in the memory 60. The appliance operation list 64 and the transmission count of a calling signal list 65 are read out from the assignment database 41 and then stored in the memory 60.

The telephone number list 63 itemizes the telephone number information of the telephone terminal device, such as the fixed telephone 35 or the portable terminal 36 used in operating the household appliances in the home through remote control. It should be noted that the telephone terminal device is not limited to types such as the fixed telephone 35 or the portable terminal 36 as long as it notifies the reception terminal device of the telephone number and is a terminal capable of transmitting calling signals.

The appliance operation list 64 itemizes information on how to operate the household appliances such as the air conditioner 42, the light fixture 43 or the water heater 44 in the home. For example, this list gives information such as turn on air conditioner, turn off air conditioner, heat bath, turn on lights, turn off lights, and reset all for resetting the appliance operations.

The transmission count of a calling signal list 65 itemizes numerical information corresponding to the appliance operations for operating the household appliance by remote control. For example, the transmission count of a calling signal list 65 itemizes one transmission for the operation of turning on the air conditioner, two transmissions for the operation of turning off the air conditioner, three transmissions for the operation of heating the bath, four transmissions for the operation of turning on the light, five transmissions for the operation of turning off the light, and seven transmissions for the operation of reset all.

The CPU 62 has a caller detecting unit 66 for detecting whether the telephone number received is registered in the telephone number list 63 in the memory 60, an appliance operation determination detecting unit 67 for determining whether the reception terminal device 39 is in a state capable of operating a household appliance, a transmission count of a calling signal counter 68 for counting the number of transmissions of a calling signal, an appliance operation detecting unit 69 for detecting whether the appliance operation that corresponds to the counted number of transmissions of a calling signal is registered in the appliance operation list 64, an appliance operation execution instructing unit 70 for executing the appliance operation, an appliance operation determination detecting unit 71 for detecting whether the appliance has operated properly, and a determination result feedback unit 72 for transmitting to the transmitting unit 61 information indicating either that the appliance has operated properly or that the appliance has not operated properly.

The caller detecting unit 66, appliance operation determination detecting unit 67, the transmission count of a calling signal counter 68, the appliance operation detecting unit 69, appliance operation execution instructing unit 70, the appliance operation determination detecting unit 71 and the determination result feedback unit 72 operate as functions of the CPU 62, which executes these functions in conformity with predetermined computer programs.

### Appliance Operation Through Remote Control

Next, the process for operating the air conditioner 42, the light fixture 43, the water heater 44 or the like within the home 38 by accessing the reception terminal device 39 via the communication network 37 from the fixed telephone 35 or the portable terminal 36 at a remote location away from the home 38 is described.

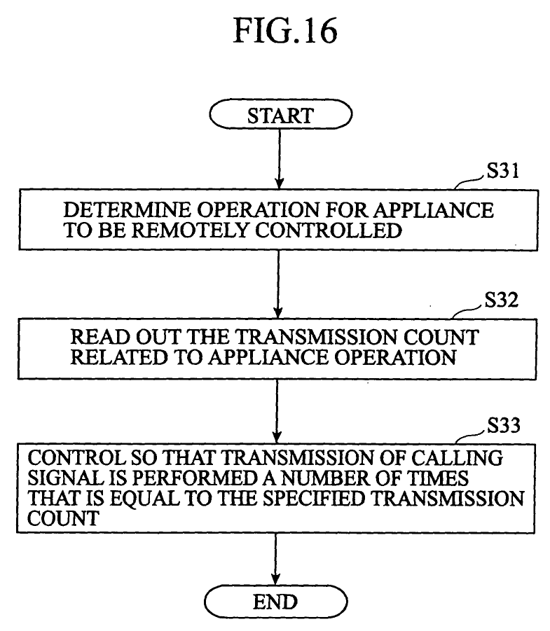

To begin with, the flowchart of FIG. 16 indicates the transmitting process through remote control on the transmission side. This process shown in the flowchart starts when the sender operates the fixed telephone 35 or the portable terminal 36 and the remote control mode allocated to arbitrary operating buttons of the fixed telephone 35 or the portable terminal 36 is selected. Upon initiation of the transmission process, the appliance operation detecting unit 53 reads out the appliance operation list 46 from the memory 48, and the display control unit 54 displays on the display unit 50 information from that appliance operation list 46.

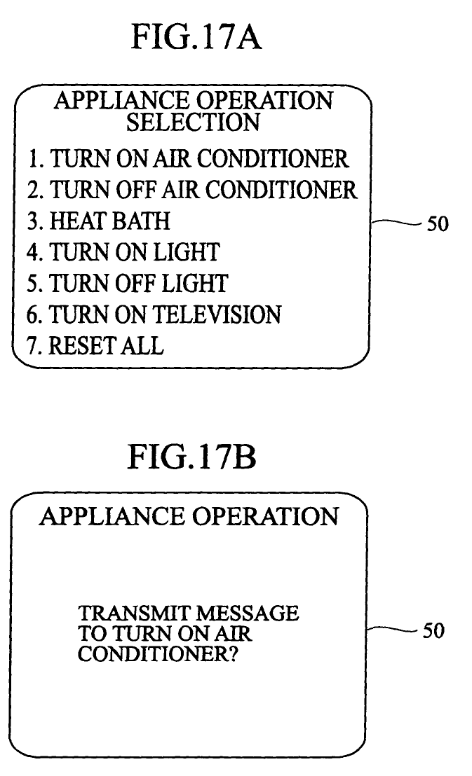

FIG. 17A illustrates an exemplary appliance operation selection screen of the appliance operation list 46 displayed on the display unit 50. As illustrated in this FIG. 17A, the display unit 50 displays operation information such as turn on air conditioner, turn off air conditioner, heat bath, turn on lights, turn off lights, turn on television, and reset all. In the case where the appliance to be remotely controlled has been improperly selected, selecting reset all allows the appliance selection to be started from the beginning.

The user selects the operation for the appliance to be remotely controlled from such displayed list by operating the operating unit 45. The appliance operation detecting unit 53 detects from the appliance operation list 46 the selected appliance operation information. When the appliance operation information is detected, the display control unit 54, as illustrated in FIG. 17B, controls the display unit 50 to display the appliance operation information selected by the user and a message inquiring as to whether the appliance operation information is to be transmitted to the user.

FIG. 17B illustrates the exemplary appliance operation information “Turn on air conditioner” selected by the user within the inquiry “Transmit message to turn on air conditioner?” questioning whether the appliance operation information should be transmitted. This inquiry is displayed on the display unit 50.

Next, when a transmission instruction is given from the user via the operating unit 45 in response to the appliance operation information transmission inquiry, the transmission determining operation detecting unit 55 outputs this transmission instruction to the transmission count of a calling signal-detecting unit 56. The transmission count of a calling signal-detecting unit 56, in STEP S32 of the flowchart of FIG. 16, retrieves from the transmission count of a calling signal list 47 the transmission count of a calling signal allocated to the selected appliance, and provides the retrieved information to the transmission control unit 57.

Next, the transmission control unit 57, in STEP S33 of the flowchart of FIG. 16, controls the transmitting unit 52 so that transmission is performed only a number of times corresponding to the retrieved transmission count of a calling signal. Specifically, the transmission control unit 57 controls the transmitting unit 52 so as to transmit to the exchange station 4 information regarding the number of transmissions of a calling signal (transmission count information), as well as both the telephone number of the transmission destination and the line establishment requiring signal leading up to the incoming call destination. The transmitting process illustrated in the flowchart of FIG. 16 is then concluded.

The information regarding the telephone number of the fixed telephone 35 or the portable terminal 36, the transmission count information, and the line establishment requiring signal transmitted from the transmitting unit 52 are then transfer-red via the antenna 51, and they are received by the exchange station 4. The exchange station 4 establishes a line with the reception terminal device 39, subsequently transmitting the calling signal to this reception terminal device 39 only a number of times corresponding to the aforementioned transmission count.

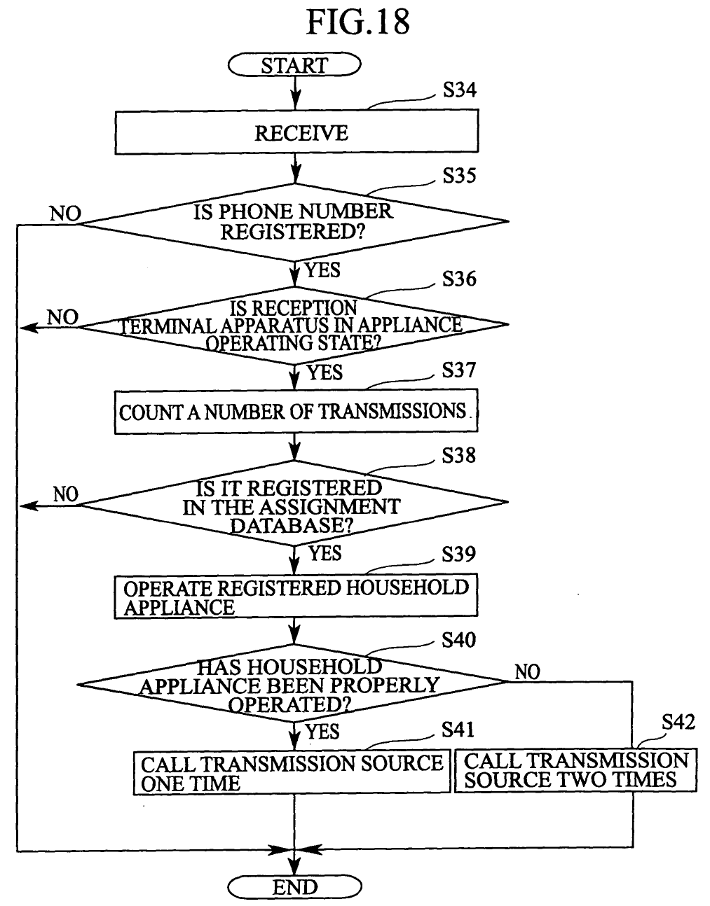

Next, the operation of the reception terminal device 39 is described. The flowchart of FIG. 18 indicates the appliance operating process of this reception terminal device 39. The process shown in this flowchart starts when the power source of the reception terminal device 39 is turned on allowing the receiving unit 59 to receive an incoming calling signal in STEP S34. Next, in STEP S35, the caller detecting unit 66 picks up the telephone number information of the caller (transmission terminal) that is transmitted along with the line establishment requiring signal, and determines whether the telephone number of the caller is registered in the telephone number list 63 in the memory 60. In the case where the telephone number is registered, the appliance operating process proceeds to STEP S36. When the telephone number is not registered and/or the telephone number is not received, this appliance operating process is concluded without execution of the appliance operation.

In STEP S36, the appliance operation determination detecting unit 67 determines whether the reception terminal device 39 is in an appliance operable state. In the case where operation of these appliances is not possible, this appliance operating process is concluded. The reception terminal device 39 being in an appliance inoperable state means, for example, that the reception terminal device 39 is not connected to any household appliances, or that the reception terminal device 39 has a setting which prevents operation of all household appliances and that setting is in an ON state.

Next, in the case where the reception terminal device 39 is in an appliance operable state, in STEP S37, the transmission count of a calling signal counter 68 counts the transmission count of a calling signal received by incrementing by one the count value for each incoming calling signal detected. When the count of the transmissions is determined, the appliance operating process proceeds to STEP S38. In this STEP S38, the appliance operation detecting unit 69 accesses the assignment database 41 so as to detect whether there is an assignment corresponding to the number of calling signals counted.

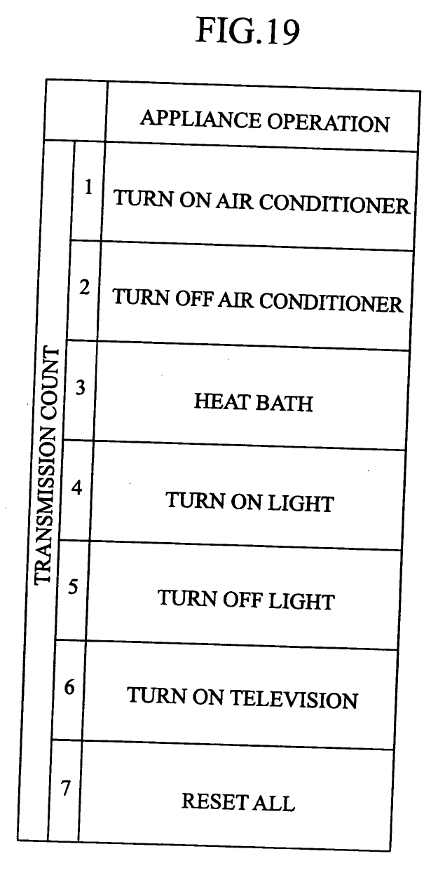

The assignment database 41, as illustrated in FIG. 19, has appliance operations allocated to the respective transmission counts registered therein. In this example, “turn on air conditioner” is allocated to one transmission, “turn off air conditioner” to two, “heat bath” to three, “turn on light” to four, “turn off light” to five, “turn on television” to six, and “reset all” to seven. It should be noted that since the user can edit this database, appliances in the home can be freely controlled.

In the case where there are no assignments according to the detected number of transmissions in the assignment database 41 (not registered), the appliance operating process is concluded. When an appliance operation corresponding to the transmission count is in the assignment database 41, the CPU 62 causes the appliance operating process to proceed to STEP S39. In STEP S39, the appliance operation execution instructing unit 70 executes the appliance operation allocated to that transmission count. In this example, since the reception terminal device 39 has detected the count of the transmissions as one, the aforementioned appliance operation execution instructing unit 70 performs the appliance operation of “turn on air conditioner” allocated to one transmission. As a result, the air conditioner 42 from among the household appliances connected to the reception terminal device 39 is turned on.

When the appliance operation in STEP 39 is completed, the appliance operating process proceeds to the next STEP S40. In STEP S40, the appliance operation determination detecting unit 71 determines whether the aforementioned appliance has operated properly. For example, when the operation of turning on the air conditioner is executed but the main power source thereof is off, the appliance operation determination detecting unit 71 assumes that the air conditioner 42 has not operated properly and transmits the determination result thereof to the determination result feedback unit 72. The appliance operation determination detecting unit 71 transmits the determination result to the determination result feedback unit 72 even when the air conditioner 42 has operated properly.

When a household appliance has operated properly, the determination result feedback unit 72, in STEP S41, instructs the transmitting unit 61 to transmit one calling signal to the transmission source (the fixed telephone 35 or the portable terminal 36). Furthermore, when a household appliance has not operated properly, the determination result feedback unit 72, in STEP S42, instructs the transmitting unit 61 to transmit two calling signals to the transmission source. In this manner, since the sender receives feedback of whether the appliance operation has been properly carried out, he/she may remotely control household appliances from outside the home 38 with assurance.

### MODIFIED EXAMPLE

It should be noted that the appliance operation list 46 stored in the memory 48 of the fixed telephone 35 or the portable terminal 36 is displayed on the display unit 50 in the third embodiment, however, it is not always necessary to display this appliance operation list 46. In that case, the user himself/herself memorizes the respective operations for the household appliances in the home 38 and the transmission counts allocated to those respective operations. In this manner, the user is also capable of controlling the household appliances in the home 38 utilizing the fixed telephone 35 or the portable terminal 36 from a remote location.

Furthermore, the household appliances mentioned in the description of the third embodiment are merely exemplary, and are not limited thereto. The reception terminal device 39 is not limited to an exclusive terminal device, and may be a personal computer, for example. Furthermore, the reception terminal device 39 may be provided with a display unit, such as a liquid crystal display, and the appliance operation information allocated to the transmission count of a calling signal received and the telephone number information of the transmission terminal received may be displayed on this display unit.

With this third embodiment, similarly to the first embodiment, despite the fact that the fixed telephone 35 or the portable terminal 36 is operated for the purpose of remote control, the telephone is answered if the reception terminal device 39 gives off the calling tone when, for example, the family is in the home 38. Accordingly, the reception terminal device 39 is set so that the calling tone is not issued until it reaches the transmitted transmission count on the occasion of the arrival of an incoming call for appliance operations. Accordingly, it is possible to prevent a person in the home 38 from improperly answering the telephone when the incoming call is for an appliance operation.

### FOURTH EMBODIMENT

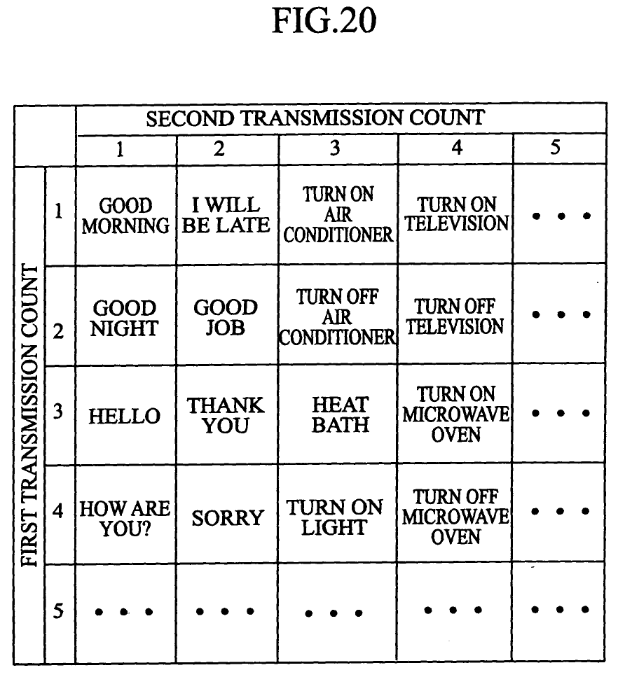

The fourth embodiment is an example where both transmission of a simple message by two or more calling operations and remote control of household appliances are performed by one terminal device. With this fourth embodiment, for example, as illustrated in FIG. 20, simple message information and appliance operation information for remotely controlling are both registered in the same database. For example, simple messages are registered for one and two transmissions of the second calling signal (the second transmission count), and appliance operation information is registered for three or more transmissions.

Hereafter, the operations in the case where household appliances in the home 38 are remotely controlled by two calling operations will be described. Since the operations for transmitting and receiving a simple message using two calling operations have been described in the second embodiment, in this fourth embodiment, only a process for remotely controlling household appliances is described. Furthermore, since the transmission operation for remotely controlling household appliances has been described in the previous third embodiment, that transmission operation is omitted in the description of this fourth embodiment, and only a process on the reception side is described. It should be noted that the same processes as those already described in the second embodiment and third embodiment are simplified in this description.

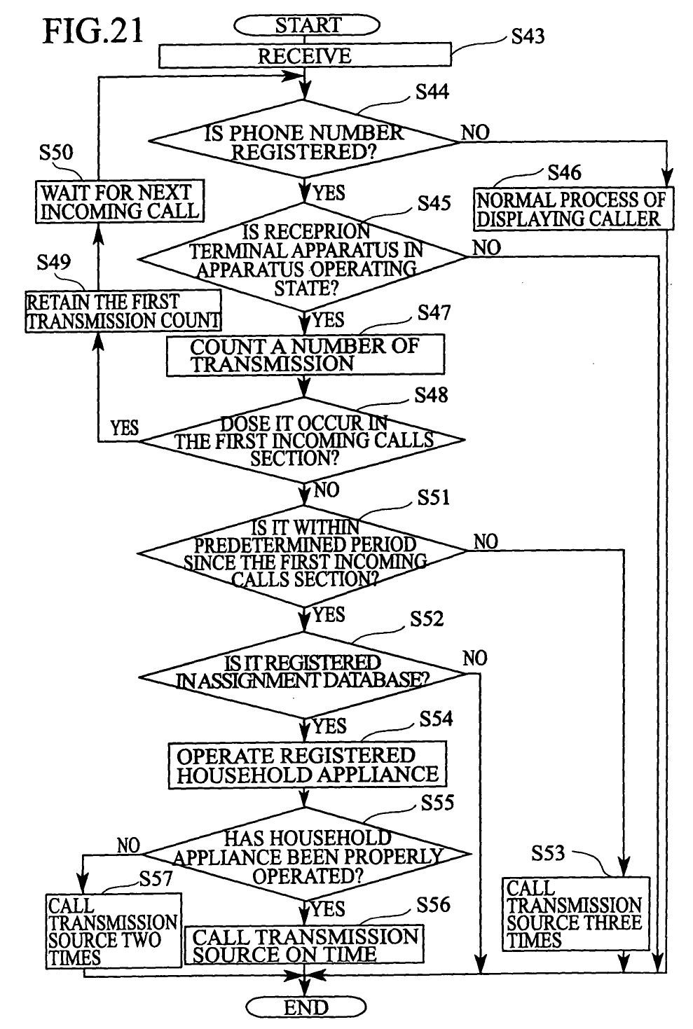

The flowchart illustrated in FIG. 21 indicates the appliance operating process of this reception terminal device 39. This appliance operating process starts when the power source of the reception terminal device 39 is turned on, and in STEP S43, the receiving unit 59 of the reception terminal device 39 detects an incoming calling signal transmitted from the fixed telephone 35 or the portable terminal 36 via the communication network 37. In STEP S44, the caller detecting unit 66 determines whether the telephone number information of the caller is registered in the telephone number list 63 in the memory 60. If the telephone number is registered, the appliance operating process proceeds to the next STEP S45. When the telephone is not registered and/or the telephone number is not received, this appliance operating process proceeds to STEP S46 without execution of the appliance operation. In STEP S46, the incoming calling signal is processed as a normal telephone call, whereby this appliance operating process is concluded.

In STEP S45, the appliance operation determination detecting unit 67 determines whether the reception terminal device 39 is in an appliance operable state. In the case where the reception terminal device 39 is not capable of operating the household appliances, this appliance operating process is concluded. In the case where the reception terminal device 39 is in an appliance operable state, in STEP S47, the transmission count of a calling signal counter 68 counts the transmission count of a calling signal received. Next, in STEP S48, the CPU 62 detects how many times there have been incoming calls from that same telephone number, the appliance operating process proceeding to STEP S49 if the calling signals occur in the first incoming calls section. In STEP S49, the CPU 62 saves in the memory 60 the transmission count of the incoming calls received during the first incoming calls section. Next, in STEP S50, the reception terminal device 39 waits for the next incoming call.

On the other hand, in step S48, if the calling signals occur in the second incoming calls section instead of the first incoming calls section, the CPU 62 proceeds to STEP S51 of the appliance operating process. In STEP S51, it is determined whether a predetermined period has elapsed since the first incoming calls section. In the case where the predetermined period has not elapsed (when within the predetermined period), the appliance operating process proceeds to STEP S52. In the case where the predetermined period has elapsed, the appliance operating process proceeds to STEP S53. In STEP S53, the CPU 62 calls the transmission source three times so as to notify the sender that the operation in response to the second incoming calls section is invalid, and the reception terminal device 39 then returns to the state of waiting for an incoming call.

When the second incoming calls section is within the predetermined period and the process proceeds to STEP S52, the appliance operation detecting unit 69 detects whether the assignment database 41 includes an assignment corresponding to the transmission counts of the first incoming calls section and the second incoming calls section. In the case where there are no assignments corresponding to the detected transmission counts registered in the assignment database 41, this appliance operating process is concluded. In the case where an assignment corresponding to the transmission counts is registered in the assignment database 41, the CPU 62 causes the appliance operating process to proceed to STEP S54.

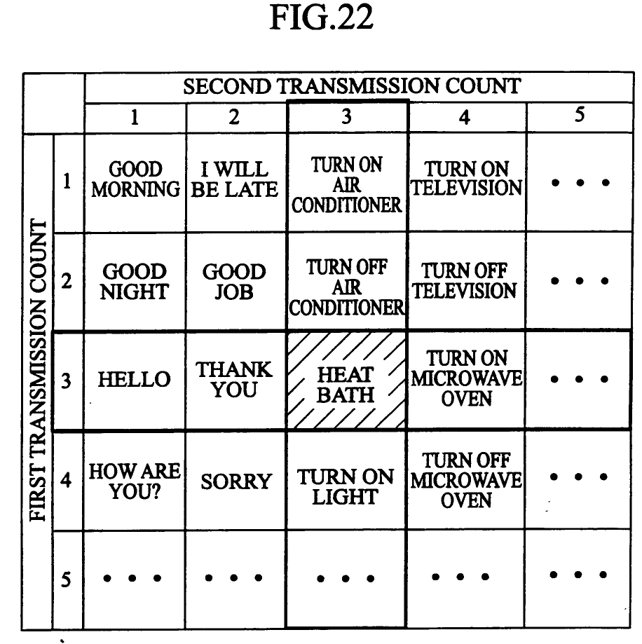

In STEP S54, the appliance operation execution instructing unit 70 executes the appliance operation allocated to the detected transmission counts. For example, as illustrated in FIG. 22, if the transmission count of the first calling signal is three, and the transmission count of the second calling signal is three, the appliance operation of “heat bath” is allocated to that combination of transmission counts. Thus, the appliance operation execution instructing unit 70 makes the water heater 44 operate to heat the bath with the power source on.

When the appliance operation in STEP 54 is completed, the appliance operating process proceeds to the next STEP S55. In STEP S55, the appliance operation determination detecting unit 71 determines whether the aforementioned appliance has operated properly. For example, when the operation of heating the bath is executed but the main power source for the water heater 44 is off, the appliance operation determination detecting unit 71 assumes that the water heater 44 has not operated properly and transmits the determination result thereof to the determination result feedback unit 72. The appliance operation determination detecting unit 71 also transmits the determination result to the determination result feedback unit 72 when the water heater 44 has operated properly.

When a household appliance has operated properly, the determination result feedback unit 72, in STEP S56, instructs the transmitting unit 61 to transmit one calling signal to the transmission source. Furthermore, when a household appliance has not operated properly, the determination result feedback unit 72, in STEP S57, instructs the transmitting unit 61 to transmit two calling signals to the transmission source. In this manner, the sender receives feedback of whether the appliance operation has been properly carried out, and therefore may remotely control household appliances from outside the home 38 with assurance.

### MODIFIED EXAMPLE

In the fourth embodiment, an example of operating household appliances in the home 38 through remote control is described, however, simple messages may be transmitted from the same terminal device utilizing this two-dimensional database. Namely, operating household appliances in the home 38 from one fixed telephone 35 or portable terminal 36 is possible, or transmitting simple messages to a communication party is possible.

It should be noted that the above embodiments have been described as allowing operations in response to incoming calls from a registered sender. However, the incoming calls do not always need to be from registered senders. In this case, transmitting devices of any kind, such as a public phone, may be employed.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An information transmission/reception method, comprising:
storing predetermined information in a transmission system and in a reception system, each piece of the predetermined information being associated with a transmission count of a calling signal;
selecting one piece of the information stored in the transmission system;
detecting the transmission count of a calling signal associated with the selected piece of information;
transmitting the calling signal to the reception system only a number of times that is equal to the detected transmission count;
counting the number of times the calling signal is received at the reception system to determine the transmission count of the received calling signals; and
retrieving from the predetermined information stored in the reception system a piece of information associated with the transmission count of the received calling signals.

2. The information transmission/reception method according to claim 1, wherein the predetermined information is appliance operation data for operating a household appliance in communication with the reception system.

3. The information transmission/reception method according to claim 2, wherein the reception system operates the household appliance according to the retrieved piece of appliance operation data.

4. The information transmission/reception method according to claim 3, wherein the reception system feeds back to the transmission system either information that the household appliance has operated properly or information that the household appliance has not operated properly.

5. The information transmission/reception method according to claim 4, wherein the feedback information is a predetermined number of calling signals, one predetermined number of calling signals indicating that the household appliance has operated properly and another predetermined number of calling signals indicating that the household appliance has not operated properly.

6. The information transmission/reception method according to claim 1, wherein the predetermined information is arranged in a data structure having n dimensions.

7. An information transmission method, comprising:
storing predetermined information in a transmission system, each piece of the predetermined information being associated with a transmission count of a calling signal;
selecting one piece of the information stored in the transmission system;
detecting the transmission count of a calling signal associated with the selected piece of information; and
transmitting the calling signal from the transmitting system only a number of times that is equal to the detected transmission count.

8. The information transmission method according to claim 7, wherein the predetermined information is appliance operation data for operating a household appliance at a remote location.

9. The information transmission method according to claim 7, wherein the predetermined information is arranged in a data structure having n dimensions.

10. An information reception method, comprising:
storing predetermined information in a reception system, each piece of the predetermined information being associated with a transmission count of a calling signal;
counting a number of times a calling signal is received at the reception system to determined the transmission count of the received calling signals; and
retrieving from the predetermined information stored in the reception system a piece of information associated with the transmission count of the received calling signals.

11. The information reception method according to claim 10, wherein the predetermined information is appliance operation data for operating a household appliance in communication with the reception system.

12. The information reception method according to claim 11, wherein the reception system operates the household appliance according to the retrieved piece of appliance operation data.

13. A computer-readable storage medium having stored thereon an information transmission program, the information transmission program comprising:
accessing predetermined information stored in a memory, each piece of the predetermined information being associated with a transmission count of a calling signal;
selecting one piece of the information from the memory;
detecting the transmission count of a calling signal associated with the selected piece of information; and
transmitting the calling signal only a number of times that is equal to the detected transmission count.

14. A computer-readable storage medium having stored thereon an information reception program, the information reception program comprising:
counting a number of times a calling signal is received to determine a transmission count of the received calling signals;
accessing predetermined information stored in a memory, each piece of the predetermined information being associated with a transmission count of a calling signal; and
retrieving from the predetermined information stored in the memory a piece of information associated with the transmission count of the received calling signals.

15. A transmitter, comprising:
a memory for storing predetermined information, each piece of the predetermined information being associated with a transmission count of a calling signal;
selecting means for selecting one piece of the information stored in said memory;
detecting means for detecting the transmission count of a calling signal associated with the selected piece of information; and
control means for controlling transmission of the calling signal only a number of times that is equal to the detected transmission count.

16. A receiver, comprising:
a memory for storing predetermined information, each piece of the predetermined information being associated with a transmission count of a calling signal;
counting means for counting a number of times a calling signal is received to determine the transmission count of the received calling signals; and
means for retrieving from said memory a piece of information associated with the transmission count of the received calling signals.

17. The receiver according to claim 16, wherein the predetermined information is appliance operation data for operating a household appliance in communication with said receiver.

18. The receiver according to claim 17, further comprising communication means in communication with said receiver, said communication means including appliance operation instructing means for operating the household appliance according to the retrieved appliance operation data.

19. The receiver according to claim 16, wherein the predetermined information is arranged in a data structure having n dimensions.

20. A transmitter-receiver, comprising:
a memory for storing predetermined information, each piece of the predetermined information being associated with a transmission count of a calling signal;
selecting means for selecting one piece of the predetermined information from said memory;
detecting means for detecting the transmission count of a calling signal associated with the selected piece of information;
control means for controlling transmission of the calling signal only a number of times that is equal to the detected transmission count;
counting means for counting a number of times the calling signal is received to determine the transmission count of the received calling signals; and
means for retrieving from said memory a piece of information associated with the transmission count of the received calling signals.

21. The transmitter-receiver according to claim 20, further comprising:
display means for displaying the retrieved piece of information.

22. An information transmission/reception system, comprising:
a memory for storing predetermined information, each piece of the predetermined information being associated with a transmission count of a calling signal;
a transmitter having selecting means for selecting one piece of the predetermined information from said memory, detecting means for detecting the transmission count of a calling signal associated with the selected piece of information, and control means for controlling transmission of the calling signal only a number of times that is equal to the detected transmission count;
a receiver having counting means for counting a number of times the calling signal is received to determine the transmission count of the received calling signals, and means for retrieving from said memory a piece of information associated with the transmission count of the received calling signals; and
an exchange station for transmitting to said receiver only the number of times that is equal to the transmission count of the calling signal in response to an instruction from said control means of said transmitter.

23. The information transmission/reception system according to claim 22, wherein the predetermined information is appliance operation data for operating a household appliance connected to said receiver.

24. The information transmission/reception system according to claim 23, wherein said receiver has appliance operation instructing means for operating the household appliance according to the retrieved appliance operation data.

25. An information transmission system, comprising:
a processor operable to execute instructions; and
instructions, the instructions including accessing predetermined information stored in a memory, each piece of the predetermined information being associated with a transmission count of a calling signal;
selecting one piece of the information from the memory;
detecting the transmission count of a calling signal associated with the selected piece of information; and
transmitting the calling signal only a number of times that is equal to the detected transmission count.

26. An information reception system, comprising:
a processor operable to execute instructions; and
instructions, the instructions including
counting a number of times a calling signal is received to determine a transmission count of the received calling signals;
accessing predetermined information stored in a memory, each piece of the predetermined information being associated with a transmission count of a calling signal; and
retrieving from the predetermined information stored in the memory a piece of information associated with the transmission count of the received calling signals.

27. The information reception system according to claim 26, wherein the instructions further comprise:
operating a household appliance according to the retrieved piece of information.

28. The information reception system according to claim 27, wherein the instructions further comprise:
feeding back to a transmission destination either information that the household appliance has operated properly or information that the household appliance has not operated properly.
